(19) United States
(12) Patent Application Publication
(10) Pub. No.: US 2007/0227007 A1
(43) Pub. Date: Oct. 4, 2007

(54) Electric shaver

(76) Inventors: Makoto Fukutani, Shigaken (JP); Toshio Ikuta, Shiga (JP)

Correspondence Address: BACON & THOMAS, PLLC, 625 SLATERS LANE, FOURTH FLOOR, ALEXANDRIA, VA, 22314, US

(21) Appl. No.: 11/802,973

(22) Filed: May 29, 2007

Related U.S. Application Data
(63) Continuation-in-part of application No. 10/895,847, filed on Jul. 22, 2004.

(30) Foreign Application Priority Data
Jul. 22, 2003 (JP) 2003-277842

(51) Int. Cl. B26B 19/02; B26B 19/20

(52) U.S. Cl. 30/43.1

(57) ABSTRACT

An electric shaver includes a plurality of outer cutter frames connected to an electric shaver main body, the outer cutter frames accommodating therein short hair cutter blocks and long hair cutter blocks. Each of the outer cutter frames is floatably and swingably movable with respect to the electric shaver main body according to an amount of pressure applied to the outer cutter frame by a skin.

This application is a Continuation-In-Part Application of application Ser. No. 10/895,847 filed on Jul. 22, 2004.

### FIELD OF THE INVENTION

The present invention relates to an electric shaver having long hair cutter blocks for use in shaving long hair and short hair cutter blocks for use in shaving short hair.

### BACKGROUND OF THE INVENTION

Conventionally, there has been disclosed an electric shaver which includes a long hair cutter block for use in shaving long hair and a short hair cutter block for use in shaving short hair which are provided in an outer cutter frame connected to an electric shaver main body. In such electric shaver, the outer cutter frame is fixedly attached to the electric shaver main body and, at the same time, the long hair cutter block and the short hair cutter block are floatably accommodated at the outer cutter frame by a spring force. Under such configuration, each of the long hair cutter block and the short hair cutter block is independently pressed against the skin, thereby enabling a shaving along a contour of the skin (see Japanese Patent Laid-open Application No. 1998-33851).

However, in the aforementioned conventional electric shaver, the outer cutter frame is fixed on the electric shaver main body and, therefore, a hand holding the electric shaver main body or an arm needs to move along the contour of the skin while shaving, which requires an inconvenient and needless motion by a user. Moreover, in order to achieve a clean cut shaving without leaving any traces of uncut hair, it is preferable to use an electric shaver having a plurality of long hair cutter blocks and short hair cutter blocks. However, in order to allow each of the multiple cutter blocks to more accurately trace the contour of the skin, the movement of the hand or the arm becomes more troublesome.

### SUMMARY OF THE INVENTION

It is, therefore, an object of the present invention to provide an electric shaver in which a plurality of long hair cutter blocks and short hair cutter blocks are accommodated to have a high shaving efficiency and, at the same time, each of the cutter blocks has a high traceability along a curved surface of a skin.

In accordance with the present invention, there is provided an electric shaver including, a plurality of outer cutter frames connected to an electric shaver main body, the outer cutter frames accommodating short hair cutter blocks and long hair cutter blocks, wherein each of the outer cutter frames is movable with respect to the electric shaver main body according to an amount of pressure applied to the outer cutter frames against a skin. By such configuration, a perfect shaving can be effectively performed without leaving uncut hairs. Besides, since the short hair cutter blocks 7 or the long hair cutter blocks 8 have a high conformability along a curved surface of a skin according to a movement of each outer cutter frame 1, a perfect shaving can be performed without greatly moving a hand holding the electric shaver main body 50 or an arm.

It is preferable that at least parts of the outer cutter frames are independently movable with respect to the electric shaver main body. Accordingly, each of the outer cutter frames 1 differently moves along various curved surface of the skin, so that each of the short hair cutter blocks 7 or long hair cutter blocks 8 can be pressurized against the skin with high accuracy.

Further, it is preferable that at least a part of the outer cutter frames is installed at least either floatably or swingably with respect to the electric shaver main body. Consequently, the short hair cutter blocks 7 or the long hair cutter blocks 8 are pressurized against the skin, thereby preventing uncut hair and providing a user with a soft feeling on the skin.

Further, it is preferable that at least a part of the long hair cutter blocks or the short hair cutter blocks is floatable with respect to outer cutter frames accommodating said at least the part of the long hair cutter blocks or the short hair cutter blocks. Therefore, it is possible to improve conformability of the short hair cutter block 7 or the long hair cutter blocks 8 against the skin or the soft feeling thereof on the skin. At the same time, in case the electric shaver is dropped, each of the cutter blocks 7 and 8 is inserted into the outer cutter frames 1, thereby absorbing an impact and preventing breakdown.

Moreover, it is preferable that at least in two outermost outer cutter frames respectively disposed at two opposite ends, long hair cutter blocks are located at farther end portions than short hair cutter blocks. Accordingly, long hair is shaved by the long hair cutter blocks 8 located at end portions and then short hair are shaved by the short hair cutter blocks 7 located at inner portions, thereby enabling an effective shaving.

Besides, it is preferable that each of at least a part of the outer cutter frames is movably connected to the electric shaver main body via an outer cutter frame block interposed between said at least the part of the outer cutter frames and the electric shaver main body. With such configuration, a self-structure of each outer cutter frame 1 can be scaled down and, further, the conformability along the curved surface of the skin can be improved.

In addition, it is preferable that the outer cutter frame block is detachably installed at the electric shaver main body. Accordingly, each of the outer cutter frames 1 is detachably installed at the electric shaver main body 50 via the outer cutter frame block 42. As a result, it is easy to exchange components of the short hair cutter blocks 7 or those of the long hair cutter blocks 8 and clean inner portions of the outer cutter frames 1.

Further, it is preferable that there is provided an up mechanism for sliding up at least a part of the long hair cutter blocks with respect to the outer cutter frames. By using the long hair cutter blocks 8, long hair that is conventionally hard to be introduced can be efficiently shaved, and an edge shaving can be easily performed.

### BRIEF DESCRIPTION OF THE DRAWINGS

The above and other objects and features of the present invention will become apparent from the following description of preferred embodiments, given in conjunction with the accompanying drawings, in which:

FIG. 1A shows a front view of an electric shaver in accordance with a first preferred embodiment of the present invention, and FIG. 1B illustrates a cross sectional view taken along the line A-A in FIG. 1A;

FIGS. 2A to 2D provide a perspective view, a plan view, a front view and a side view of a head section of the electric shaver, respectively;

FIG. 3 describes an exploded perspective view of the head section of the electric shaver;

FIG. 4 depicts an outer cutter frame assembled with a long hair cutter block of the electric shaver;

FIGS. 5A and 5B present an entire long hair cutter block and an entire short hair cutter block of the electric shaver, respectively;

FIG. 6 represents a cross sectional view of the long hair cutter block of the electric shaver;

FIGS. 7A to 7D illustrate the outer cutter frame of the electric shaver, wherein FIG. 7A shows a state where the short hair cutter block and the long hair cutter block are assembled with an outer cutter frame block; FIGS. 7B and 7C show a side view and a rear view of the outer cutter frame of the electric shaver, respectively; and FIG. 7D depicts the outer cutter frame block attached to the outer cutter frame;

FIG. 8 shows a structure connecting the outer cutter frame of the electric shaver with the outer cutter frame block thereof;

FIGS. 9A and 9C describe a structure of an attachment and a separation of the outer cutter frame of the electric shaver, wherein FIGS. 9A and 9B provide a front view and a fragmentary sectional perspective view of the outer cutter frame, respectively, and FIG. 9C presents a cross sectional view of principal parts thereof;

FIGS. 10A and 10B are explanatory diagrams of a slide-up of the electric shaver, representing an initial state and a slide-up state, respectively;

FIGS. 11A and 11B illustrate an engaged state of the short hair cutter block of the electric shaver, wherein FIG. 11A and FIG. 11B describe an enlarged view of a B section shown in FIG. 7A and that obtained in case the short hair cutter block is slidable, respectively;

FIGS. 12A to 12C show an initial state, a floating state and a swing state of an electric shaver main body of the electric shaver, respectively;

FIGS. 13A to 13D provide an electric shaver in accordance with another preferred embodiment of the present invention, wherein FIGS. 13A and 13B depict a plan view and a side view of a head section, and FIGS. 13C and 13D describe a plan view and an engaged state of a central outer cutter frame, respectively;

FIGS. 14A and 14B present a plan view and an engaged state of a different structured central outer cutter frame of the electric shaver, respectively; and

FIGS. 15A and 15B set forth a plan view and a side view of a head section of an electric shaver in accordance with still another preferred embodiment of the present invention.

### DETAILED DESCRIPTION OF THE PREFERRED EMBODIMENTS

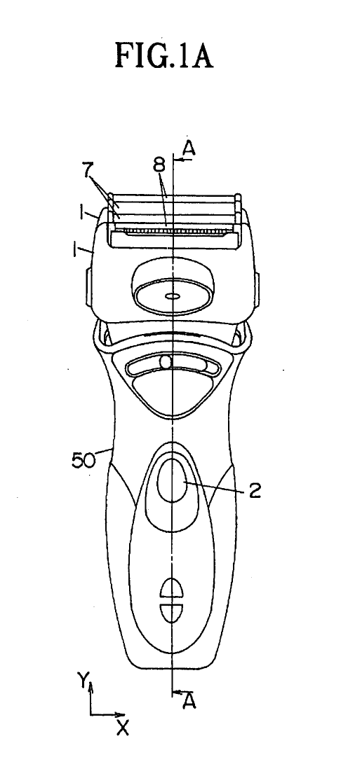

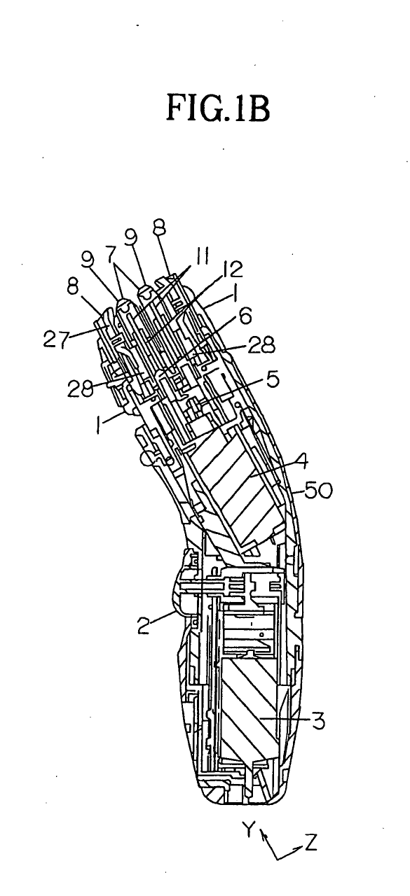

Hereinafter, preferred embodiments of the present invention will be described with reference to the accompanying drawings. FIGS. 1A and 1B illustrate an electric shaver in accordance with a first preferred embodiment of the present invention. The electric shaver mainly includes an electric shaver main body 50 held by a user and a pair of outer cutter frames 1 connected to the electric shaver main body 50. The electric shaver main body 50 contains a power supply unit 3, e.g., a rechargeable battery; a motor 4 rotated by a power supplied from the power supply unit 3; and a converter 5 for converting a rotational motion of the motor 4 into a reciprocating motion, wherein a main body driver 6 protruded from the electric shaver main body 50 is capable of engaging in a reciprocating motion by the converter 5. Further, a power switch 2 provided at a front portion of the electric shaver 50 is used as a control device for controlling an on-off operation of supplying power to the motor 4.

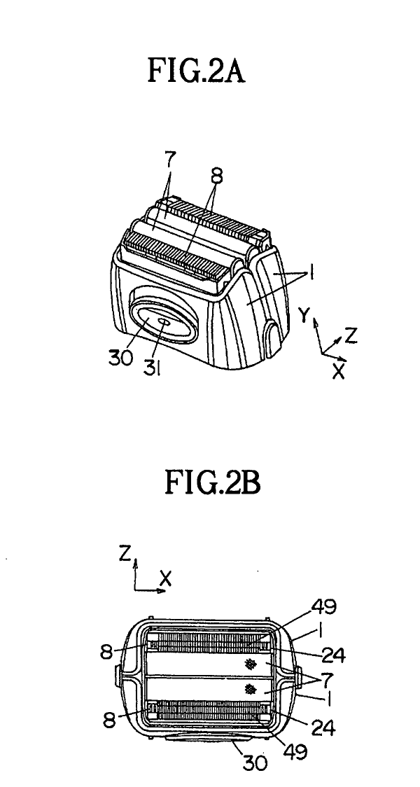

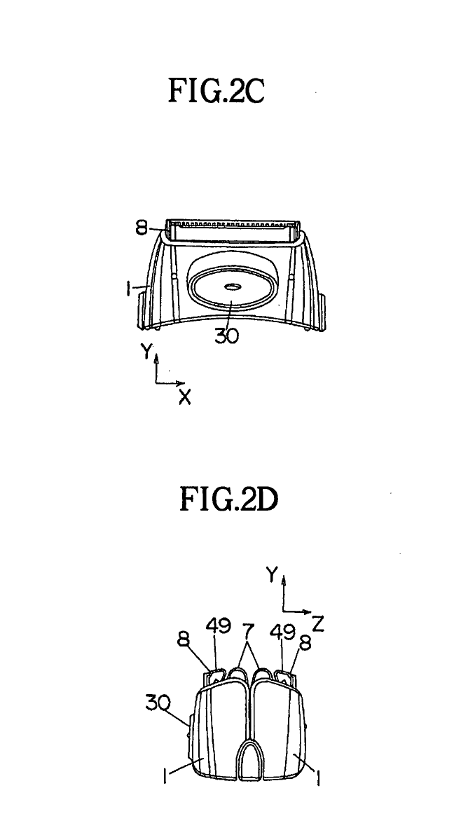

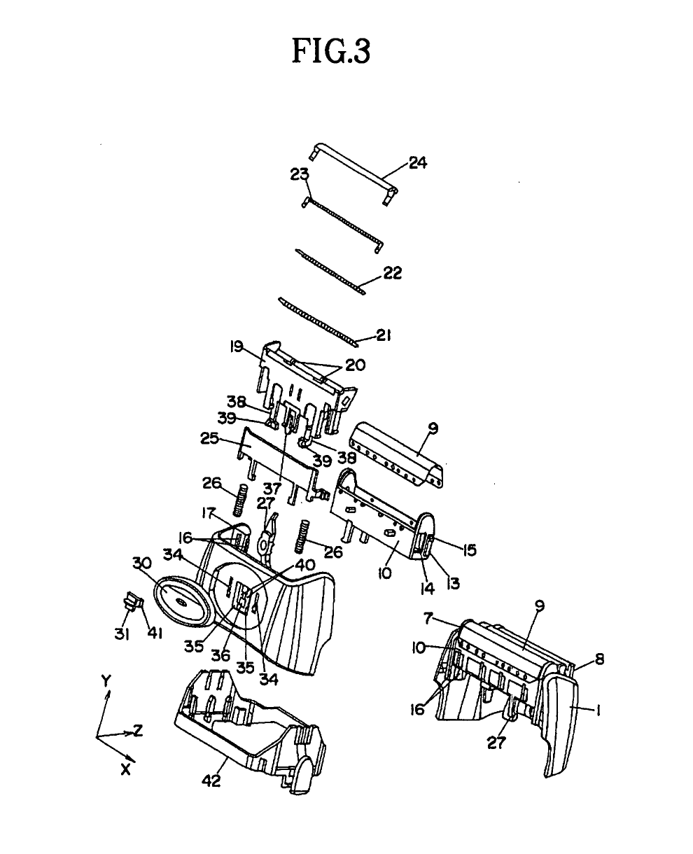

As illustrated in FIGS. 2A to 2D and FIG. 3, the outer cutter frames 1 have a shape of an approximately rectangular frame member cut in half at a middle portion of shorter sides. Each of the outer cutter frames 1 is provided with a short hair cutter block 7 for use in shaving short hair and a long hair cutter block 8 for use in shaving long hair which have outwardly protruding blades respectively accommodated thereon. Further, in each of the outer cutter frames 1, the long hair cutter block 8 is located at a farther end portion than the short hair cutter block 7. The outer cutter frames 1 are in contact with each other to form the approximate rectangular shape. Under such configuration, the short hair cutter blocks 7 are located adjacent to each other and, are insertion fitted by a pair of long hair cutter blocks 8 at both end portions.

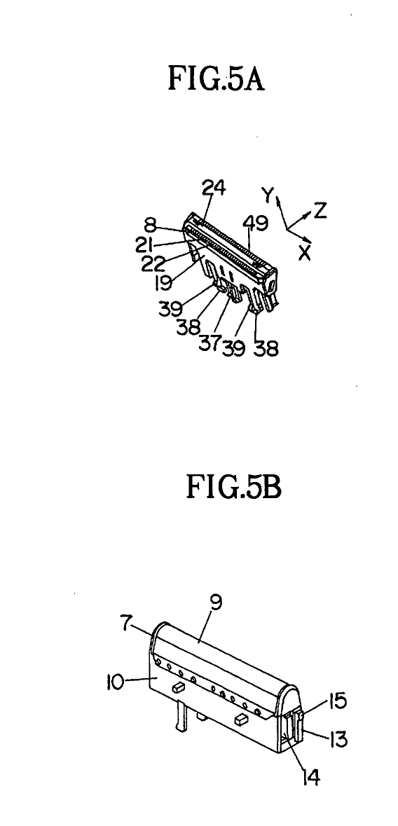

As shown in FIG. 5B, the short hair cutter block 7 mainly includes an outer cutter 9 made of a metal foil provided with a plurality of blade holes and an approximately rectangular frame-shaped inner cassette 10 for accommodating thereon the outer cutter 9 having an inverse U-shaped cross section by a heat sealing. Further, an inner cutter 11 installed at the main body driver 6 protruding from the electric shaver main body 50 via a push up spring 12 is provided inside the inner cassette 10 such that the inner cutter 11 is pressed against an inner surface of the outer cutter 9 by a spring force of the push-up spring 12. Moreover, the inner cutter 11 engages in a reciprocating motion in X-direction as a single body with the main body driver 6 while making a sliding contact with the inner surface of the outer cutter 9, thereby enabling shaving of short hairs. Protrudently installed at both end portions of the inner cassette 10 are respectively a protruded piece 13 having a rectangular cross section and a spring hook 14 also having a rectangular cross section and flexibility in an inward and outward direction. Further, a lock hook 15 is protrudently disposed on the protruded piece 13.

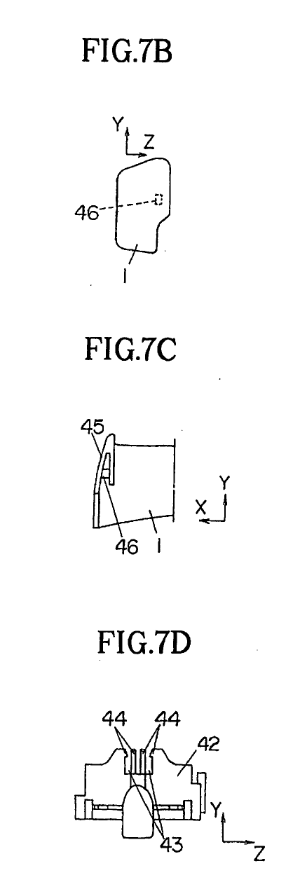

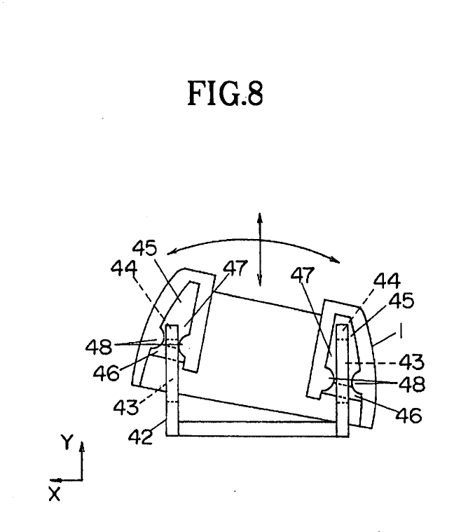

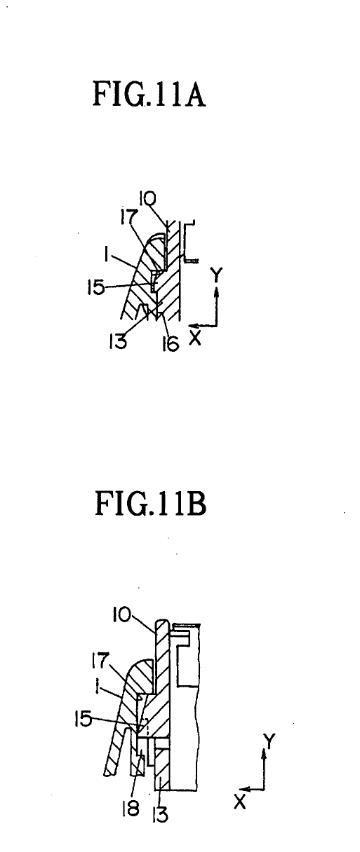

As illustrated in FIG. 3 or FIG. 7A, a pair of grooves 16 are formed at inner surfaces of both end portions of each outer cutter frame 1, respectively, and, at the same time, an engagement recess portion 17 is provided at a bottom portion of one groove 16. After engaging the protruded piece 13 of the inner cassette 10 and the spring hook 14 with the pair of grooves 16, respectively, by sliding the spring hook 14 along the grooves 16 while being inwardly bent, the lock hook 15 of the protruded piece 13 is engaged with the recess portion 17, thereby securing the inner cassette 10 in the outer cutter frame 1. In the above-described embodiment of the present invention, a movement of the inner cassette 10 in Y-direction is restricted by engaging the lock hook 15 with the recess portion 17 in Y-direction (i.e., a direction projected from a tip of a blade of the electric shaver) without having a gap therebetween, as shown in an enlarged view of FIG. 11A. However, as illustrated in, e.g., FIG. 11B, the lock hook 15 can be engaged with the recess portion 17 in Y-direction via a predetermined gap 18 therebetween, thereby enabling the inner cassette 10 to slide within a small range in Y-direction. In such case, a pressing force of the push-up spring 12 is applied to the inner cassette 10 via the inner cutter 11 or the outer cutter 9 in Y-direction, so that an entire short hair cutter block 7 can float with respect to the outer cutter frame 1 for accommodating a corresponding short hair cutter block 7. Herein, the floatable state indicates that the short hair cutter blocks 7 are slidable within a small range in a predetermined direction while the pressing force is applied thereto.

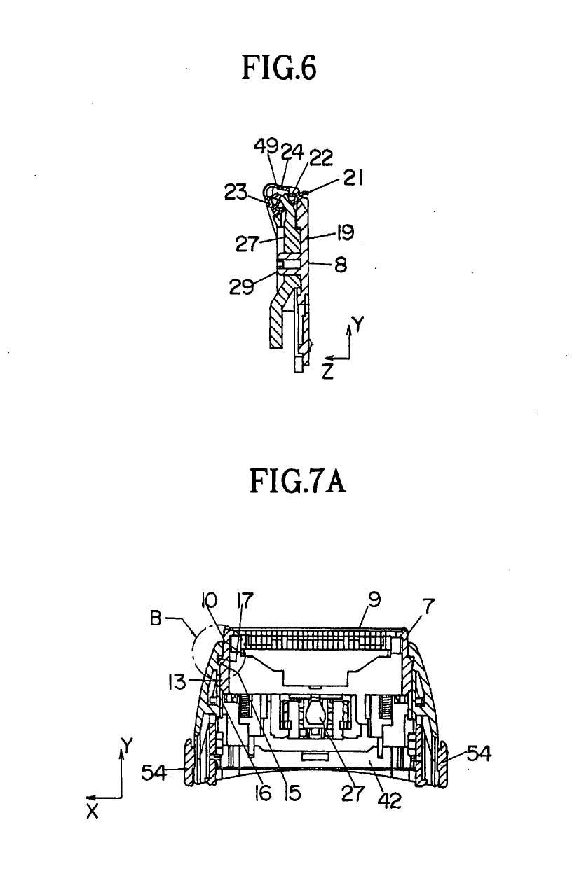

Furthermore, as can be seen from FIGS. 3 to 6, the long hair cutter block 8 includes a trimmer block 19; a stationary cutter 21 fixedly engaged with protruded portions 20 protrudently installed at the trimmer block 19; a movable blade 22 slidably guided by the protruded portions 20 in X-direction (i.e., a sliding direction of the end of the blade of the electric shaver), and disposed so as to insert the stationary cutter 21 between the movable blade 22 and the trimmer block 19; a push down spring 23 connected with the trimmer block 19, for pressing the movable blade 22 against the stationary cutter 21; a trimmer cover 24 connected to the trimmer block 19 to cover the push down spring 23; and a trimmer guide 25 attached to the trimmer block 19.

The trimmer guide 25 is slidably installed at an inner surface of the outer cutter frame 1 within a small range in Y-direction. Further, since a pair of trimmer springs 26 applying a pressing force to the trimmer guide 25 in the Y-direction are interposed between the trimmer guide 25 and the outer cutter frame 1, the trimmer guide 25 can be floatably accommodated in Y-direction with respect to the outer cutter frame 1. As described above, since the trimmer block 19 is attached to the floatable trimmer guide 25, the trimmer block 19 via the trimmer guide 25 and, further, the entire long hair cutter block 8 can be accommodated floatable in Y-direction with respect to the outer cutter frame 1.

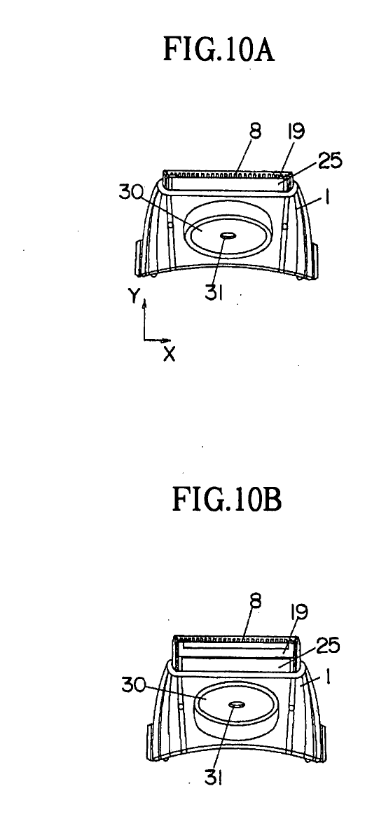

Herein, the trimmer block 19 is slidably attached to the trimmer guide 25 within a small range in Y-direction, and one of the outer cutter frames 1 (e.g., a front outer cutter frame in this example) has an up mechanism for sliding up the trimmer block 19 in Y-direction with respect to a corresponding outer cutter frame 1. Such up mechanism varies an amount of protrusion of the trimmer block 19 from the outer cutter frame 1 depending on a sliding operation of a trimmer handle 30 in Y-direction, wherein the trimmer handle 30 is attached to an outer surface of the outer cutter frame 1 (see FIGS. 10A and 10B). Further, installed at a central portion of the trimmer handle 30 is a lock button 31 for selectively locking the sliding of the corresponding trimmer handle 30.

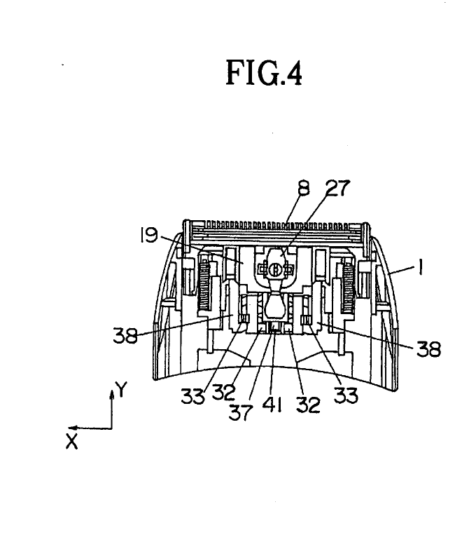

Specifically, each pair of push-up hooks 32 and push-down hooks 33 are protrudently installed at a rear surface of the trimmer handle 30 and, the lock button 31 is attached to the central portion thereof. By inserting such hooks 32 and 33 and the lock button 31 through elongate grooves 34, 35 and 36 formed in Y-direction at five spots on the outer cutter frame 1, the trimmer handle 30 can be slidably attached to the outer cutter frame 1. The lock button 31 is interposed between the trimmer handle 30 and the outer cutter frame 1 and, at the same time, a leading end portion 41 of the lock button 31 is arranged to be in contact with a front surface of a leading end portion of an elastic piece 37 protrudently installed at the trimmer block 19. Furthermore, protrudently installed at both sides of the trimmer block 19 are a pair of approximately L-shaped push-down load receiving pieces 38 having therebetween the elastic piece 37. The elastic piece 37 is located adjacent to the push-up hooks 32 of the trimmer handle 30 in Y-direction, and the push-down hooks 33 of the trimmer handle 30 are located to a Y-directional vicinity of the push-down load receiving pieces 38 (see FIG. 4).

Projections 39 having a semicircular cross section are provided at surfaces where each of the push-down load receiving pieces 38 faces the outer cutter frame 1 (see FIG. 3 or the like). By a bending of the push-down load receiving pieces 38, the projections 39 pass over protrusions (not shown) of a semicircular cross section installed at an inner surface of the outer cutter frame 1, whereby the trimmer block 19 slides up. However, in case the lock button 31 is not being pushed, the leading end portion 41 of the corresponding lock button 31, which has a wide width, is unslidably engaged with engagement projection portions 40 installed protrudently from an inner surface of the long hole 36. Accordingly, the trimmer handle 30 cannot be operated and, thus, the slide-up of the trimmer block 19 is prevented. Meanwhile, in case the lock button 31 is being pushed, the leading end portion of the corresponding lock button 31 is free from the long hole 36 and becomes slidable and, at the same time, a leading end portion of the elastic piece 37 is bent inward to be in contact with the push-up hooks 32. Further, by applying a force to the trimmer handle 30 in Y-direction in the pushed state of the lock button 31, the push-up hooks 32 transfer an upward thrust force in Y-direction to the trimmer block 19 via the elastic piece 37. Consequently, the projections 39 of each push-down load receiving piece 38 passes over a protrusion of the outer cutter frame 1, whereby the trimmer block 19 slides up to a certain amount of protrusion. If the lock button 31 is released from the pushed state when the sliding up of the trimmer block 19 is completed, the leading end portion 41 of the lock button 31 is located at an inside of the long hole 36 where it passes over the engagement projection portions 40 in Y-direction. Thereafter, the leading end portion 41 thereof is engaged with the engagement projection portions 40 from an opposite side, thereby preventing a sliding of the trimmer handle 30.

In order to release the slide-up, the trimmer handle 30 needs to slide downward while pushing the lock button 31. In this case, the leading end portion 41 of the lock button 31 is free from the long hole 36 and becomes slidable and, at the same time, the push-down hooks 33 of the trimmer handle 30 transfer a push-down force to the trimmer block 19 via the push-down load receiving pieces 38. Accordingly, the projections 39 pass over the protrusion of the outer cutter frame 1 while bending the push-down load receiving pieces 38, thereby returning the trimmer block 19 to an initial position thereof.

The movable blade 22 of each long hair cutter block 8 engages in a reciprocating motion in X-direction by a trimmer driver 27. End portions of the trimmer driver 27 are connected to a second driver 28 fixed on the main body driver 6 and the operation blade 22, respectively, and a central portion thereof is supported by an axis 29 protrudently installed at the trimmer block 19. The trimmer driver 27 swings pivoting on the axis 29 in linkage with the second driver 28 reciprocating with the main body driver 6 as a single unit. Such swinging motion of the trimmer driver 27 is designed to be converted into a reciprocating motion of the movable blade 22. At this time, the movable blade 22 slides in a state of being pressed against the stationary cutter 21, thereby shaving long hair. The trimmer driver 27 swings in linkage with the second driver 28 even in case the long hair cutter block 8 slides up. Especially, in case of the slide-up state, the movable blade 22 is appropriately used for a shaving of sideburns.

As described above, the electric shaver of the above example has a structure that each of the pair of outer cutter frames 1 accommodating one short hair cutter block 7 and one long hair cutter block 8 can separately and freely float and swing on a plane substantially parallel to a moving direction of the inner cutter 11 or the movable blade 22, i.e., on an X-Y plane, with respect to the electric shaver main body 50 according to an amount of pressure applied against the skin. Since each of the outer cutter frames 1 is movably installed to an approximately rectangular frame-shaped outer cutter frame block 42 fixed on the electric shaver main body 50, the outer cutter frame 1 can be slidably connected to the electric shaver main body 50 via the outer cutter frame block 42. Hereinafter, a detailed configuration thereof will be described.

As illustrated in FIGS. 3 and 7D, both end portions of the outer cutter frame block 42, which are provided in X-direction, are formed relatively higher in Y-direction than other portions and a pair of slits 43 having openings formed in Y-direction are provided at each of the end portions thereof. Further, a separation prevention hook 44 is provided at an inner surface near the opening of each of the slits 43. Meanwhile, as illustrated in FIGS. 7A to 7D and FIG. 8, deep grooves 45 each having an approximately inverse V-shaped cross section are opened at inner surfaces of both end portions of the outer cutter frame 1 provided in X-direction, wherein approximately half of both end portions of the outer cutter frame block 42 are inserted into the deep grooves 45 in Y-direction. Further, formed across the inner wall surfaces of the deep groove 45 is a rib-shaped connecting member 46 for connecting the inner wall surfaces facing each other in X-direction. Moreover, in the present example, a connection between the outer cutter frame 1 and the outer cutter frame block 42 is achieved in such a manner that each end portion of the outer cutter frame block 42 is inserted into each of the deep grooves 45 at the end portions of the outer cutter frame 1 and, at the same time, the connecting member 46 in each of the deep grooves 45 is movably inserted into each of the slits 43 of the outer cutter frame block 42 in one-to-one correspondence. The connecting members 46 are slidable within a small range in Y-direction in the slits 43 and, at the same time, are prevented from being slipped therefrom by the separation prevention hooks 44. Each of the outer cutter frames 1 is movable with respect to the outer cutter frame block 42, i.e., the electric shaver main body 50, within the above-described small range in Y-direction. Herein, since the pressing force of the push-up spring 12 is applied in Y-direction to each of the outer cutter frames 1 attached to the electric shaver main body 50 via the short hair cutter block 7 accommodated by a corresponding outer cutter frame 1, each of the outer cutter frames 1 can independently float in Y-direction with respect to the electric shaver main body 50.

As can be seen from FIG. 8, voids 47 in X-direction allowing a slight swing of the outer cutter frame 1 are formed between each end portion of the outer cutter frame block 42 and the deep grooves 45 into which such end portions are movably inserted. The deep grooves 45 run in Z-direction, i.e., substantially normal to a moving direction of the inner cutter 11 or the movable blade 22 such that an opening portion of each deep groove 45 is wider than a base portion thereof. Further, each end portion of the outer cutter frame block 42 has a plate shape a thickness of which is smaller than a width of the deep groove 45. In addition, the inner wall surfaces of each deep groove 45 restrict the swinging of the outer cutter frame 1 to a movement along a swing path, i.e., the swinging of a head on the X-Y plane marked by an arrow of the FIG. 8. Installed at the inner wall surfaces of each deep groove 45 are a pair of semicircular rib-shaped limiting projections 48. The pair of limiting projections 48 are protrudently installed to face each other in X-direction, and leading end portions of the limiting projection 48 are located such that both inside and outside of end portions of the outer cutter frame block 42 are provided therebetween. Due to such configuration, each of the outer cutter frames 1 moves floatably (i.e., linearly) and swingably (i.e., rotationally) with respect to the electric shaver main body 50. Further, as described above, the pressing force of the push-up spring 12 is applied in Y-direction to each of the outer cutter frames 1 via the short hair cutter block 7. Such pressing force returns by a swing motion the outer cutter frame under a state where the head is inclined, to an initial position thereof.

As described above, in the electric shaver of the first preferred embodiment of the present invention, the pair of outer cutter frames 1 each accommodates one pair of short hair cutter blocks 7 and long hair cutter blocks 8, thereby providing a high shaving efficiency without leaving any trace of uncut hair. In addition, each of the outer cutter frames 1 accommodating one of the short hair cutter blocks 7 and the long hair cutter blocks 8 can independently float and swing with respect to the electric shaver main body 50, and the short hair cutter blocks 7 and the long hair cutter blocks 8 can also independently float with respect to each of the outer cutter frame 1, so that each cutter block 7 and 8 can provide a high traceability along a contour of the skin. Each outer cutter frame 1 is not necessarily floatable and swingable with respect to the electric shaver main body 50. That is, it is allowed that the outer cutter frame 1 is floatable and swingable. The swingable state indicates that the outer cutter frame 1 can swing within a certain swing path while applying the pressing force for returning the outer cutter frame 1 to the initial state thereof.

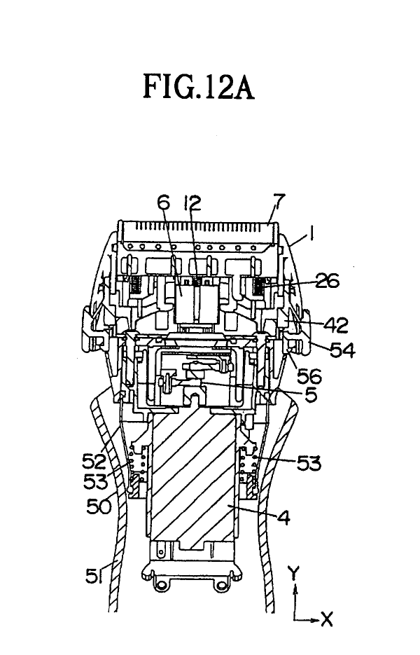

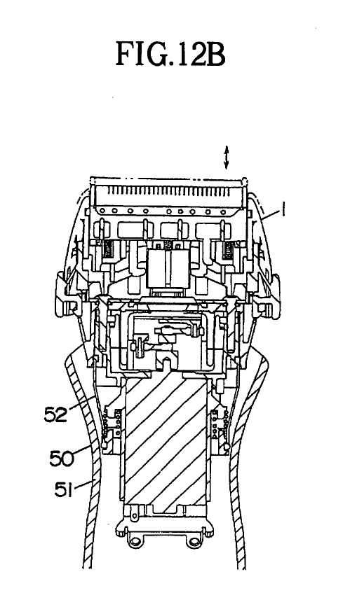

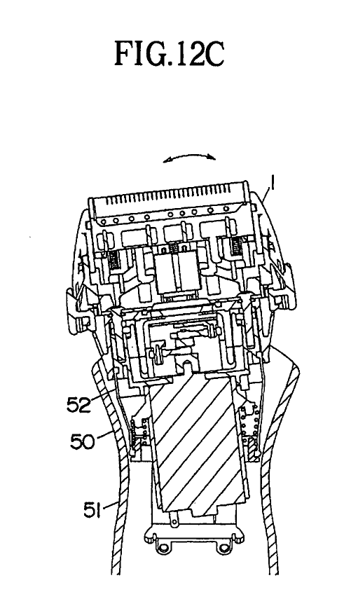

Further, as shown in FIGS. 12A to 12C, in the electric shaver of the first preferred embodiment, the electric shaver main body 50 includes two blocks incorporating: a main body grip portion 51 serving as a grip unit and having a power switch 2 or a power supply unit 3; and a main body head portion 52 having the motor 4, the converter 5 or the main body driver 6, for reciprocating the outer cutter frames 1 attached thereto. The main body head portion 52 is connected to the main body grip portion 51 via main body floating springs 53 interposed therebetween around a peripheral portion of the main body head portion 52 in such a way that the main body head portion 52 is floatable (i.e., linearly movable) in Y-direction and swingable (i.e., rotationally movable) on the X-Y plane with respect to the main body grip portion 51. Therefore, in addition to the aforementioned floating and swinging of each of the outer cutter frames 1 with respect to the main body grip portion 51 according to an amount of pressure applied by the outer cutter frames 1 against the skin, the main body head portion 52 to which the outer cutter frames 1 are attached floats or swings with respect to the main body grip portion 51. As a result, the short hair cutter blocks 7 or the long hair cutter blocks 8 can trace along the contour of the skin within a wide operational range and, further, with a greater degree of freedom with respect to the main body grip portion 51.

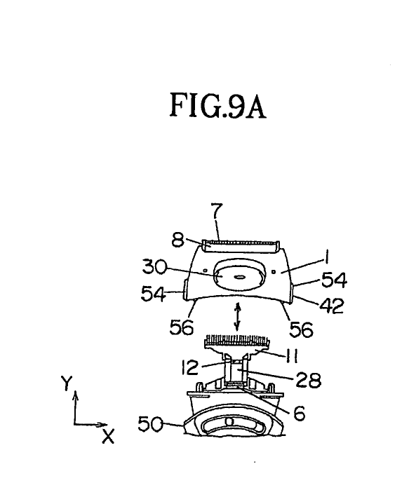

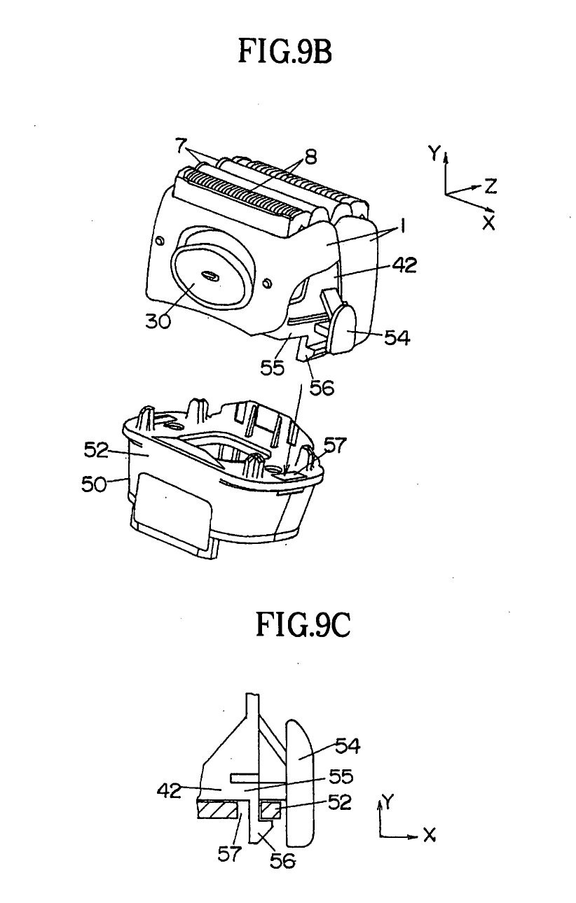

FIGS. 9A to 9C depict an attachment and a separation motion of the outer cutter frames 1 of the first preferred embodiment of the present invention. As described in FIGS. 9A to 9C, since the outer cutter frame block 42 interposed between the outer cutter frame 1 and the electric shaver main body 50 is detachably installed at the electric shaver main body 50, the attachment and the separation of the outer cutter frames 1 are performed via such outer cutter frame block 42. In the first preferred embodiment of the present invention, as an attachment and a separation structure between the outer cutter frame block 42 and the electric shaver main body 50, retaining buttons 54 is protrudently installed at outer surfaces of both end portions of the outer cutter frame block 42 provided in X-direction and, at the same time, resilient member 55 bent inward by pushing corresponding retaining buttons 54 are provided. Besides, retaining hooks 56 are protruded from the resilient member 55. Provided at the main body head portion 52 of the electric shaver main body 50 are engagement holes 57 through which the retaining hooks 56 are inserted. With the retaining hooks 56 elastically engaged with the engagement holes 57, the outer cutter frame block 42 is attached to the electric shaver main body 50. In case the outer cutter frame block 42 is separated from the electric shaver main body 50, the retaining buttons 54 are inwardly pushed to bend the resilient member 55, so that the engagement between the retaining hooks 56 and the engagement holes 57 can be released. Thereafter, the outer cutter frame block 42 is lifted up in Y-direction and, accordingly, the outer cutter frames 1 are separated as a single unit with the outer cutter frame block 42.

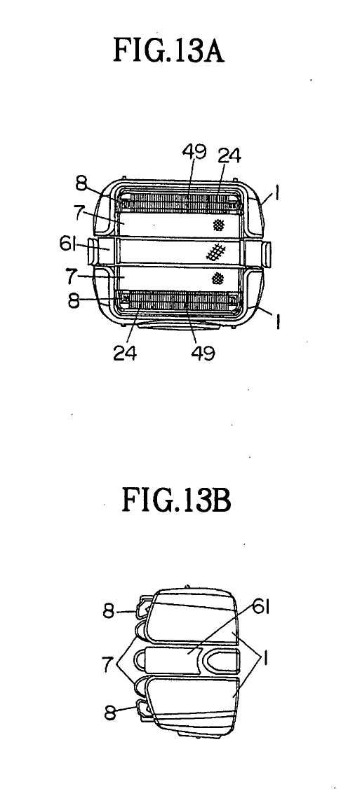

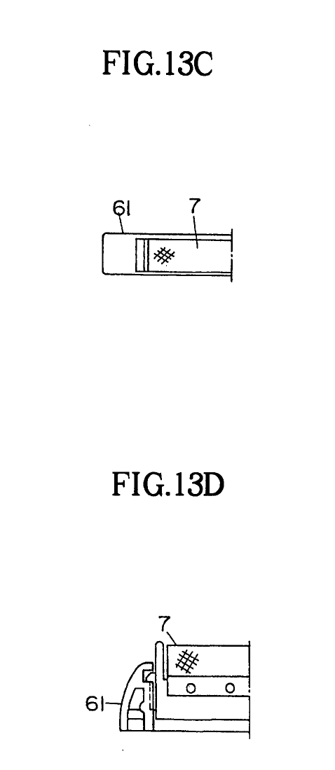

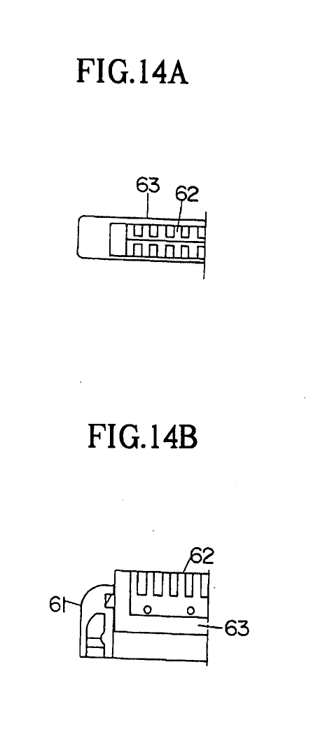

Hereinafter, an electric shaver in accordance with a second preferred embodiment of the present invention will be described. Further, like reference numerals will be given to like parts having substantially the same functions, and reference description thereof will be omitted, whereas different numerals will be given to parts having different functions, and a description thereof will be followed below. As illustrate in FIGS. 13A to 13D, in the electric shaver of the second preferred embodiment of the present invention, an additional outer cutter frame 61 is provided between the pair of outer cutter frames 1 accommodating the short hair cutter blocks 7 and long hair cutter blocks 8 and, at the same time, the short hair cutter blocks 7 are accommodated by the corresponding outer cutter frame 61, thereby providing a much improved shaving efficiency in comparison with the electric shaver in accordance with the first preferred embodiment. Furthermore, as shown in FIGS. 14A and 14B, a long hair cutter block 63 including a slit cutter 62 can be accommodated by the outer cutter frame 61. Even in such case, the shaving efficiency is improved in comparison with that of the electric shaver in accordance with the first preferred embodiment. Although the short hair cutter blocks 7 or the long hair cutter block 63 of the second preferred embodiment are stationary in Y-direction accommodated with respect to the outer cutter frame 61, they can be accommodated in the floatable state. Further, it is preferable that the outer cutter frame 61 is at least either floatable or swingable with respect to the electric shaver main body 50 same as the pair of outer cutter frames 1 having therebetween the outer cutter frame 61.

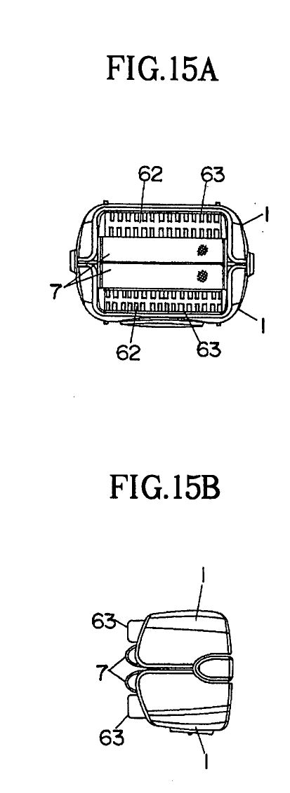

Hereinafter, an electric shaver in accordance with a third preferred embodiment of the present invention will be described. Further, like reference numerals will be given to like parts having substantially the same functions, and reference description thereof will be omitted, whereas different numerals will be given to parts having different functions, and a description thereof will be followed below. As illustrated in FIGS. 15A and 15B, in the electric shaver of the third preferred embodiment, each of the outer cutter frames 1 accommodates the short hair cutter block 7 and the long hair cutter block 63 including the slit cutter 62. Due to a structure of the slit cutter, long hair can be cleanly shaved.

In the above-described electric shavers, the long hair cutter blocks 8 and 63 are located at a farther end portion than that of the short hair cutter block 7 in each of the outer cutter frames 1. Accordingly, long hair are shaved short by the long hair cutter block 8 positioned at the end portion and then the short hair are further shaved by the short hair cutter block 7 installed at a central portion, so that the shaving can be performed with high accuracy without leaving any trace of uncut hair. Especially, concavely installed at an outer surface of the trimmer cover 24 of the long hair cutter block 8 are a plurality of reception slits 49 extending in a Z direction (i.e., a direction perpendicular to a sliding direction of the tip of the cutter) in the electric shaver of the first and other preferred embodiments of the present invention. Therefore, mid-length hair or inclined short hair that passed through the long hair cutter block 8 are guided by such reception slits 49 and then smoothly introduced into the short hair cutter block 7 in a state where tips of hair are neatly arranged in the Z direction.

In the preferred embodiments of the present invention, there are provided a plurality of short hair cutter blocks or long hair cutter blocks, such that a shaving can be effectively performed without leaving any trace of uncut hair. In addition, each of the short hair cutter block or the long hair cutter block has a high traceability along a contour of the skin due to a movement of each outer cutter frame. As a result, without engaging in much movement in a hand holding the electric shaver main body or an arm, a highly effective shaving can be obtained without leaving any trace of uncut hair.

While the invention has been shown and described with respect to the preferred embodiments, it will be understood by those skilled in the art that various changes and modifications may be made without departing from the spirit and scope of the invention as defined in the following claims.

What is claimed is:

1. An electric shaver comprising, a plurality of outer cutter frames connected to an electric shaver main body, the outer cutter frames accommodating therein short hair cutter blocks and long hair cutter blocks, wherein each of the outer cutter frames is floatably and swingably movable with respect to the electric shaver main body according to an amount of pressure applied to the outer cutter frames by a skin.

2. The electric shaver of claim 1, wherein each hair cutter block includes a stationary cutter and a movable cutter and each of the outer cutter frames is floatably and swingably movable on a plane substantially parallel to a moving direction of the movable cutter.

3. The electric shaver of claim 1, further comprising an outer cutter frame block fixedly mounted on the electric shaver main body, the outer cutter frames being movably installed on the outer cutter frame block,
wherein each of the outer cutter frames includes two opposite end portions into each of which one of two opposite end portions of the outer cutter frame block is loosely inserted to allow the outer cutter frames to make floatable and swingable movements independently with respect to each other.

4. The electric shaver of claim 3, wherein each of said two opposite end portions of each of the outer cutter frames is provided with a groove into which said one of the end portions of the outer cutter frame block is inserted, said one of the end portions of the outer cutter frame block having a plate shape of which a thickness is smaller than a width of the groove.

5. The electric shaver of claim 4, wherein the groove runs substantially normal to a moving direction of a movable cutter included in a hair cutter block such that an opening portion of the groove is wider than a base portion thereof.

6. The electric shaver of claim 4, wherein a couple of protrusions are formed inside the groove and said one of the end portions of the outer cutter frame block is movably placed between the protrusions, allowing each of the outer cutter frames to move floatably and swingably with respect to the outer cutter frame block.

7. The electric shaver of claim 4, wherein the groove has a connecting member formed across inner wall surfaces thereof and said one of the end portions of the outer cutter frames block is provided with a slit into which the connecting member is movably inserted such that the connecting member is slidable along the slit.

8. The electric shaver of claim 7, wherein the slit is provided with a separation prevention member preventing the connecting member from being separated from the slit.

9. The electric shaver of claim 1, wherein the electric shaver main body includes:
a main body head portion having the outer cutter frames attached thereto; and
a main body grip portion,
wherein the main body head portion is connected to the main body grip portion via a plurality of resilient members disposed around a peripheral portion thereof, so that the main body head portion is floatably and swingably movable with respect to the main body grip portion.

10. The electric shaver of claim 1, wherein at least two of the outer cutter frames are independently movable with respect to each other.

11. The electric shaver of claim 1, wherein at least two of the hair cutter blocks accommodated in the outer cutter frames are independently movable with respect to each other.

12. An electric shaver comprising:
an electric shaver main body; and
a plurality of outer cutter frames connected to the electric shaver main body, each of the outer cutter frames having a short hair cutter block and a long hair cutter block,
wherein each of the outer cutter frames is linearly and rotationally movable with respect to the electric shaver main body.

13. The electric shaver of claim 12, wherein each hair cutter block includes a stationary cutter and a movable cutter and each of the outer cutter frames is linearly and rotationally movable on a plane substantially parallel to a moving direction of the movable cutter.

14. The electric shaver of claim 12, further comprising an outer cutter frame block fixedly mounted on the electric shaver main body, the outer cutter frames being movably installed on the outer cutter frame block,
wherein each of the outer cutter frames includes two opposite end portions into each of which one of two opposite end portions of the outer cutter frame block is loosely inserted to allow the outer cutter frames to make linear and rotating movements independently with respect to each other.

15. The electric shaver of claim 14, wherein each of said two opposite end portions of each of the outer cutter frames is provided with a groove into which said one of the end portions of the outer cutter frame block is inserted, said one of the end portions of the outer cutter frame block having a plate shape of which a thickness is smaller than a width of the groove.

16. The electric shaver of claim 15, wherein the groove runs substantially normal to a moving direction of a movable cutter included in a hair cutter block such that an opening portion of the groove is wider than a base portion thereof.

17. The electric shaver of claim 15, wherein a couple of protrusions are formed inside the groove and said one of the end portions of the outer cutter frame block is movably placed between the protrusions, allowing each of the outer cutter frames to move linearly and rotationally with respect to the outer cutter frame block.

18. The electric shaver of claim 15, wherein the groove has a connecting member formed across inner wall surfaces thereof and said one of the end portions of the outer cutter frames block is provided with a slit into which the connecting member is movably inserted such that the connecting member is slidable along the slit.

19. The electric shaver of claim 18, wherein the slit is provided with a separation prevention member preventing the connecting member from being separated from the slit.

20. The electric shaver of claim 12, wherein the electric shaver main body includes:
a main body head portion having the outer cutter frames attached thereto; and
a main body grip portion,
wherein the main body head portion is connected to the main body grip portion via a plurality of resilient members disposed around a peripheral portion thereof, so that the main body head portion is linearly and rotationally movable with respect to the main body grip portion.
